(19) United States
(12) Patent Application Publication
(10) Pub. No.: US 2007/0082801 A1
(43) Pub. Date: Apr. 12, 2007

(54) Interfolder with pre-forming transfer roll

(75) Inventors: Greg Kauppila, Ashland, WI (US); Chad Ryczek, Washburn, WI (US); Dennis Couturier, Washburn, WI (US)

Correspondence Address: MICHAEL BEST & FRIEDRICH, LLP, 100 E WISCONSIN AVENUE, Suite 3300, MILWAUKEE, WI, 53202, US

(73) Assignee: C. G. Bretting Manufacturing Co., Inc., Ashland, WI (US)

(21) Appl. No.: 11/246,443

(22) Filed: Oct. 7, 2005

(51) Int. Cl. B31F 1/10

(52) U.S. Cl. 493/435

(57) ABSTRACT

An interfolding apparatus including a knife roll, a first interfolding roll, a second interfolding roll, and a transfer roll. The knife roll cuts sheets from a stream of web material issuing from a source in a downstream direction. The first interfolding roll is positioned downstream of the knife roll and receives the sheets. The first interfolding roll rotates in a first direction and the second interfolding roll rotates in a second direction. The first and second interfolding rolls interfold the sheets with additional sheets received by the second interfolding roll. A transfer roll is positioned between the knife roll and the first interfolding roll. The transfer roll has a non-uniform surface configuration and rotates in the second direction and receives the sheets from the knife roll, forms a bend in each of the sheets, and transfers the formed sheets to the first interfolding roll.

### BACKGROUND

The present invention relates to interfolding apparatuses, and more specifically to the transfer of sheets onto interfolding rolls of the interfolding apparatuses.

Various combinations and types of rolls can be present in an interfolding apparatus. A typical interfolding apparatus includes at least two interfolding rolls, at least one knife or cutting roll, and at least one feed roll for pulling streams of web material into the interfolding apparatus. The web material is generally cut at or near the knife rolls and is eventually transferred to a nip between the interfolding rolls.

The succession of sheets entering the nip is such that a middle portion of a reference sheet on a first interfolding roll enters the nip at the same time as trailing and leading edges of downstream and upstream sheets, respectively, positioned on a second interfolding roll. The leading and trailing edges are positioned adjacent a tucker of the second interfolding roll. The tucker pushes or tucks the middle portion of the reference sheet into a gripper (either mechanical or vacuum) of the first interfolding roll as the tucker and gripper pass through the nip. The gripper receives the middle portion and the trailing and leading edges from the tucker, folds the middle portion capturing the leading and trailing edges within the fold, and conveys and releases the fold to an adjacent side of a stack of interfolded sheets being built below the interfolding rolls. As the interfolding rolls continue rotation, a gripper of the second interfolding roll receives a middle portion of the upstream sheet and the associated leading and trailing edges from a tucker of the first interfolding roll, folds the middle portion capturing the associated leading and trailing edges, and conveys and releases the fold to the adjacent side of the stack of interfolded sheets.

This process is repeated in an alternating fashion between the first and second interfolding rolls. To insure that the associated leading and trailing edges are properly folded within the middle portion of the sheet being folded, it is important to control the position of the leading and trailing edges on the interfolding rolls, and more particularly relative to the tucker of the interfolding roll.

Known interfolders attempt to maintain the position of the leading and trailing edges during interfolding by providing vacuum ports on the interfolding rolls. However, during interfolding as described above, a tucker forces a middle portion of a sheet into a recess of an opposite gripper. The length of sheet forced within the gripper must be compensated for by stretch or rupture of the sheet or by movement of one, or both, of the leading and trailing edges of the sheet being folded. In some cases, this will alter the position of the leading edge (i.e., draw it closer to the middle portion) such that the leading edge is pulled from the downstream gripper which performed the previous fold. In other cases, this will alter the position of the trailing edge such that the trailing edge is pulled from its respective vacuum port. In some extreme cases, tucking a middle portion of a sheet within an opposite gripper will cause the trailing edge of the sheet being folded to become freed from the gripper or the leading edge to become freed from the vacuum port. Where an edge moves or becomes freed, the edge is not tucked tightly within the fold and a visible discontinuity in the stack could result. In the case of a freed edge, interruption of the interfolding could occur.

### SUMMARY

Some embodiments of the invention provide an interfolding apparatus and a method of interfolding sheets of web material that improves the control of the position of the sheets on the interfolding rolls during interfolding.

In one embodiment, the invention provides an interfolding apparatus including a knife roll, a first interfolding roll, a second interfolding roll, and a transfer roll. The knife roll is rotatable about an axis and is operable to cut sheets from a stream of web material issuing from a source in a downstream direction. The first interfolding roll is positioned downstream of the knife roll and is adapted to receive the sheets. The first interfolding roll is rotatable in a first direction. The second interfolding roll is rotatable in a second direction and is disposed adjacent to the first interfolding roll to define a nip therebetween. The first and second interfolding rolls are rotatable to interfold the sheets with additional sheets received by the second interfolding roll. A transfer roll is positioned between the knife roll and the first interfolding roll. The transfer roll has a non-uniform surface configuration and is rotatable in the second direction. The transfer roll is operable to receive the sheets from the knife roll, to form a bend in each of the sheets received from the knife roll, and to transfer the formed sheets to the first interfolding roll.

In another embodiment, the invention provides a method of interfolding sheets of web material. The method includes issuing web material in a downstream direction from a source, cutting with a knife roll the stream of web material into sheets, transferring each sheet to a transfer roll, forming with the transfer roll a bend in the middle portion of each sheet, transferring each formed sheet to an interfolding roll, and interfolding the formed sheet on the interfolding roll with at least one other sheet from an adjacent interfolding roll.

Other aspects of the invention will become apparent by consideration of the detailed description and accompanying drawings.

### BRIEF DESCRIPTION OF THE DRAWINGS

FIG. 1 is a side view illustrating an interfolding apparatus of one embodiment of the present invention.

FIG. 2 is an enlarged side view of a portion of the interfolding apparatus shown in FIG. 1, illustrating a sheet on a knife roll.

FIG. 3 is a view similar to FIG. 2, illustrating a leading edge of the sheet being transferred to a transfer roll from the knife roll.

FIG. 4 is a view similar to FIG. 2, illustrating a middle portion of the sheet being formed into a bend between the knife roll and the transfer roll.

FIG. 5 is a view similar to FIG. 2, illustrating the leading edge of the sheet being transferred to an interfolding roll from the transfer roll.

FIG. 6 is a view similar to FIG. 2, illustrating the formed middle portion of the sheet being transferred into a gripper of the interfolding roll from the transfer roll.

FIG. 7 is a side view of a portion of the interfolding apparatus shown in FIG. 1, illustrating the sheet being interfolded between the interfolding roll and an adjacent interfolding roll.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

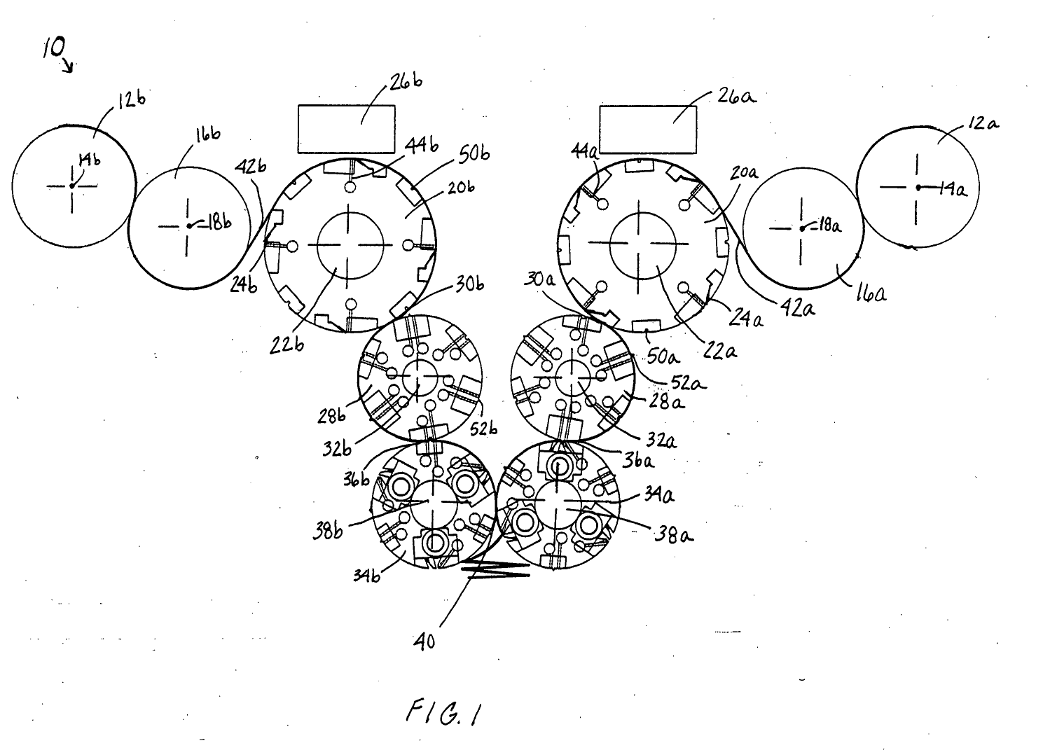

An interfolder, or interfolding apparatus 10, of one embodiment of the present invention is illustrated in FIG. 1. The interfolding apparatus 10 includes a set of outer pull rolls 12a, 12b that are mounted for rotation about axes 14a, 14b. A set of inner pull rolls 16a, 16b are adjacent the outer pull rolls 12a, 12b and are mounted for rotation about axes 18a, 18b. Knife rolls 20a, 20b are mounted for rotation about axes 22a, 22b. The knife rolls 20a, 20b contain blades 24a, 24b that contact respective stationary anvil bars 26a, 26b. Transfer rolls 28a, 28b are adjacent knife rolls 20a, 20b to form nips 30a, 30b, respectively. The transfer rolls 28a, 28b are mounted for rotation about axes 32a, 32b. Interfolding rolls 34a, 34b are positioned adjacent the transfer rolls 28a, 28b to form nips 36a, 36b, respectively. The interfolding rolls 34a, 34b are mounted for rotation about axes 38a, 38b. The interfolding rolls 34a, 34b are adjacent to one another to form a nip 40.

The interfolding apparatus 10 is capable of interfolding streams of continuously flowing web material 42a, 42b. The interfolding apparatus 10 can be divided into two sides that are mirror images of one another. Therefore, only a side “b” will be described in detail, with the understanding that the other side “a” performs the same functions, only that the movement is opposite to that of side “b”. For example, clockwise rotation of a roll on side “b” would mean that the complementary roll on the side “a” would have counterclockwise rotation.

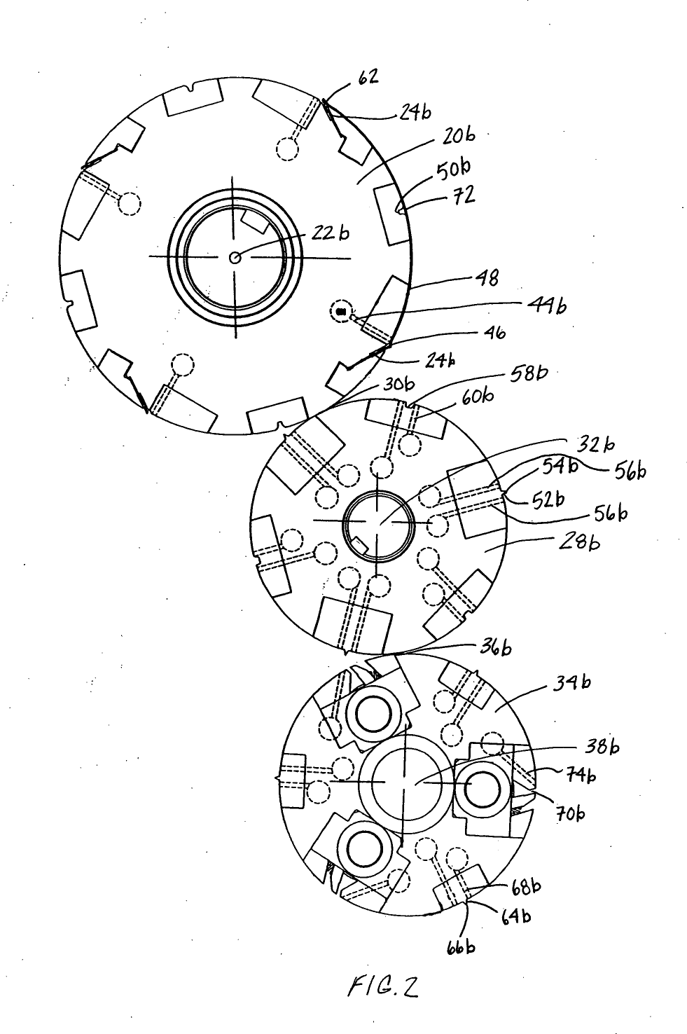

As more clearly shown in FIG. 2, the knife roll 20b includes a vacuum port 44b adjacent each individual blade 24b. In the embodiment illustrated in FIGS. 1-7, the knife roll 20b includes four blades 24b with four corresponding vacuum ports 44b. The distance between blades 24b corresponds to the length of a sheet 48 cut from the stream of web material 42b. In other words, the sheet 48 extends across a circumferential length that is equal to 14 of the circumference of the knife roll 20b. A circumferential length is defined as the length of the portion of the roll circumference between leading and trailing edges of the sheet assuming that the roll radius is continuous and disregarding any non-uniformities on the roll surface, such as protuberances or grooves. The knife roll 20b also includes four grooves 50b positioned between adjacent sets of blades 24b.

The forming blades 52b of transfer roll 28b protrude from the periphery of transfer roll 28b and end at a point 54b. Vacuum ports 56b are located on opposite sides of the forming blade 52b. The transfer roll 28b also includes grooves 58b positioned between adjacent sets of forming blades 52b. Vacuum ports 60b are located on either side of each respective groove 58b.

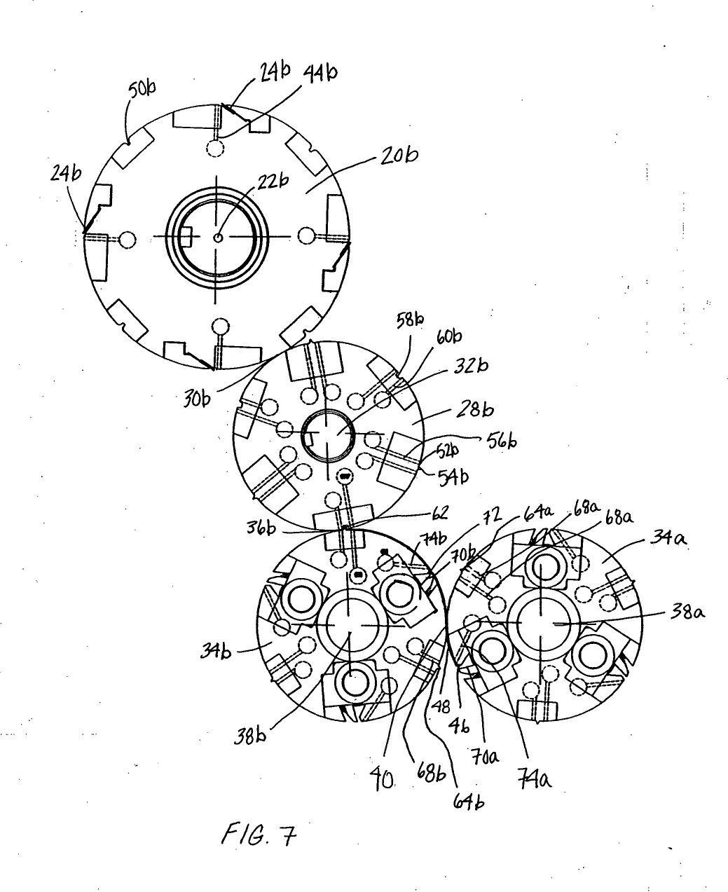

The tuckers 64b of the interfolding roll 34b are similar to the forming blades 52b of transfer roll 28b in that the tuckers 64b protrude from the periphery of the interfolding roll 34b and end at a point 66b. Vacuum ports 68b are located on both sides of the tucker 64b. As shown in FIG. 7, the interfolding roll 34b also includes grippers 70b positioned between adjacent sets of tuckers 64b. The grippers 70b can include their own vacuum ports 74b located adjacent the gripper 70b. Tucker 64b of interfolding roll 34b is received within groove 58b of transfer roll 28b, and tucker 64b is received within gripper 70a during rotation of the transfer roll 28b and interfolding rolls 34a, 34b.

The forming blades 52b are received within grooves 50b to pre-form the sheet 48 with a bend prior to creasing the sheet 48 with a gripper 70b. In some embodiments, the pre-forming operation of the forming blades 52b and grooves 50b does not leave a crease mark in the sheet 48 if the sheet 48 were to be removed from the interfolding apparatus 10 after being pre-formed by the forming blades 52b and the grooves 50b. In these embodiments, a crease forms at the middle portion 72 of sheet 48 when the gripper 70b of interfolding roll 34b pinches the bent portion of the sheet 48, as discussed in more detail below. In other embodiments, a crease can be formed by the transfer roll 28b.

As shown in FIG. 1, in operation, streams of web material 42a, 42b are fed from separate paper feeds (not shown). As illustrated in FIG. 1, the streams of web material 42b, 42a are transferred to outer pull rolls 12b, 12a, respectively. Referring now to the “b” side of the interfolding apparatus, outer pull roll 12b is rotating in a clockwise direction about axis 14b to draw the stream of web material 42b toward the inner pull roll 16b. The inner pull roll 16b is rotating in a counterclockwise direction about axis 18b such that the first stream of web material 42b can be transferred to the knife roll 20b. Other methods and arrangements are available for transferring streams of web material to the knife rolls, as is well known to one of ordinary skill in the art.

As shown in FIG. 2, when transferred to the knife roll 20b, a sheet 48 is cut from the first stream of web material 42b when the blade 24b contacts the anvil 26b. Other methods and arrangements are available for cutting streams of web material into sheets on a knife roll, as is well known to one of ordinary skill in the art. For clarity, only one sheet 48 is shown. In general, for the illustrated embodiment, adjacent sheets of web material cut by the knife roll 20b would be present on the upstream and downstream sides of the sheet 48. The knife roll 20b successively cuts sheets from the first stream of web material 42b with the blade 24b. The vacuum port 44b is operable to hold the leading edge 46 of the sheet 48 onto the knife roll 20b.

FIG. 2 illustrates a leading edge 46 of the sheet 48 aligned with blade 24b and held against the periphery of the knife roll 20b by vacuum port 44b. The trailing edge 62 of sheet 48 is aligned with a cutting edge of the blade 24b. Initially, the sheet 48 is not received within the groove 50b on the knife roll 20b. However, upon rotation of the knife roll, the groove 50b receives a forming blade 52b of the adjacent transfer roll 28b.

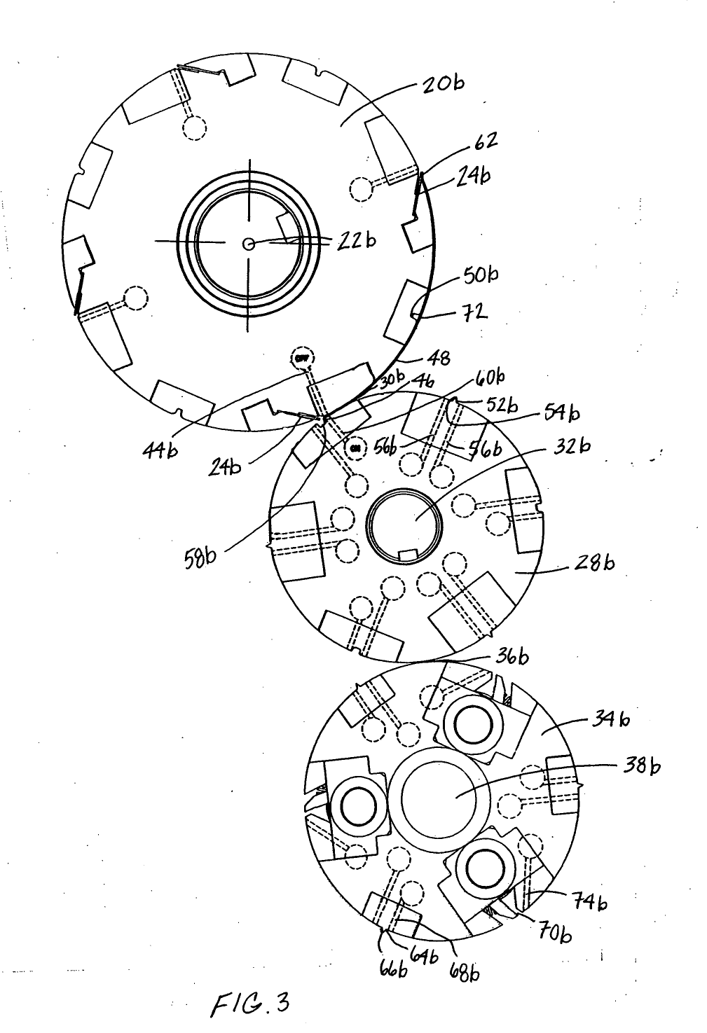

FIG. 3 illustrates the sheet 48 downstream from the first position shown in FIG. 2. As the knife roll 20b rotates clockwise, and the transfer roll 28b rotates counterclockwise, the sheet 48 begins to transfer from the knife roll 20b to the transfer roll 28b. More specifically, the leading edge 46 of the sheet 48 is drawn by vacuum port 60b adjacent the groove 58b of the transfer roll 28b. The vacuum ports 60b hold the leading and trailing edges 46, 62 of the sheet 48 against the transfer roll 28b and partially over the groove 58b. The suction force of vacuum port 60b is stronger than the suction force of vacuum port 44b at that point in rotation of the transfer roll 28b and knife roll 20b such that the sheet 48 is released from vacuum port 44b and held by vacuum port 60b.

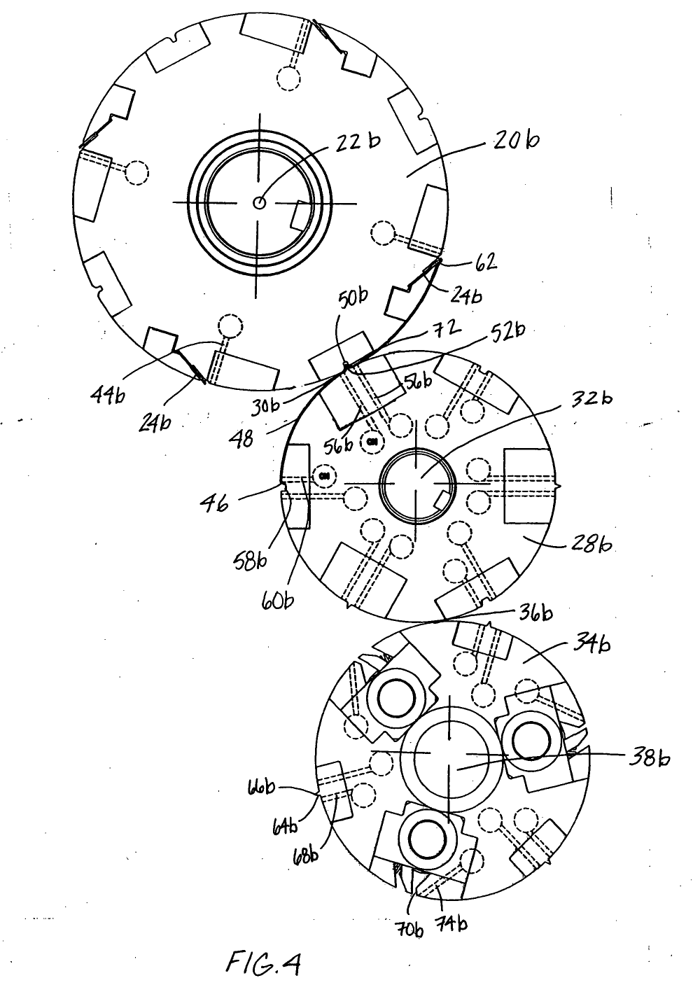

As illustrated in FIG. 4, the knife roll 20b and the transfer roll 28b have progressed in rotation such that the forming blade 52b of the transfer roll 28b is inserted into the groove 50b of the knife roll 20b and the sheet 48 is in a position downstream from the position shown in FIG. 3. The insertion of the forming blade 52b into the groove 50b of the knife roll 20b forms a bend in the sheet 48 at the middle portion 72 such that the sheet 48 becomes pre-formed. The bend in the sheet 48 is held against the periphery of the transfer roll 28a due to the vacuum force and the positioning of vacuum ports 56b on the transfer roll 28b. The sheet 48 changes from having a first peripheral length on the knife roll 20b to having a second peripheral length on the transfer roll 28b that is shorter than the first peripheral length.

The second peripheral length of the sheet 48 on the transfer roll 28b is shorter than the first peripheral length of the sheet 48 on the knife roll 20b because as the forming blade 52b is inserted into the groove 50b, the sheet 48 is transferred across the protruding surface of the forming blade 52b. Since the forming blade 52b protrudes past the uniform radial surface of the roll, the peripheral length of the sheet 48 is shorted by the added distance required to cover the forming blade 52b. The circumference of the transfer roll 28b is less than ¾ of the circumference of the knife roll 20b. In other embodiments, the circumference of the transfer roll 28b is not equally divisible by the sheet length. For example, the circumference of the knife roll 20b is equal to four sheet lengths, but the circumference of the transfer roll 28b is not equally divisible by 3 sheets. Instead, the circumference of the transfer roll 28b is equal to a number between 2 and 3 sheet lengths.

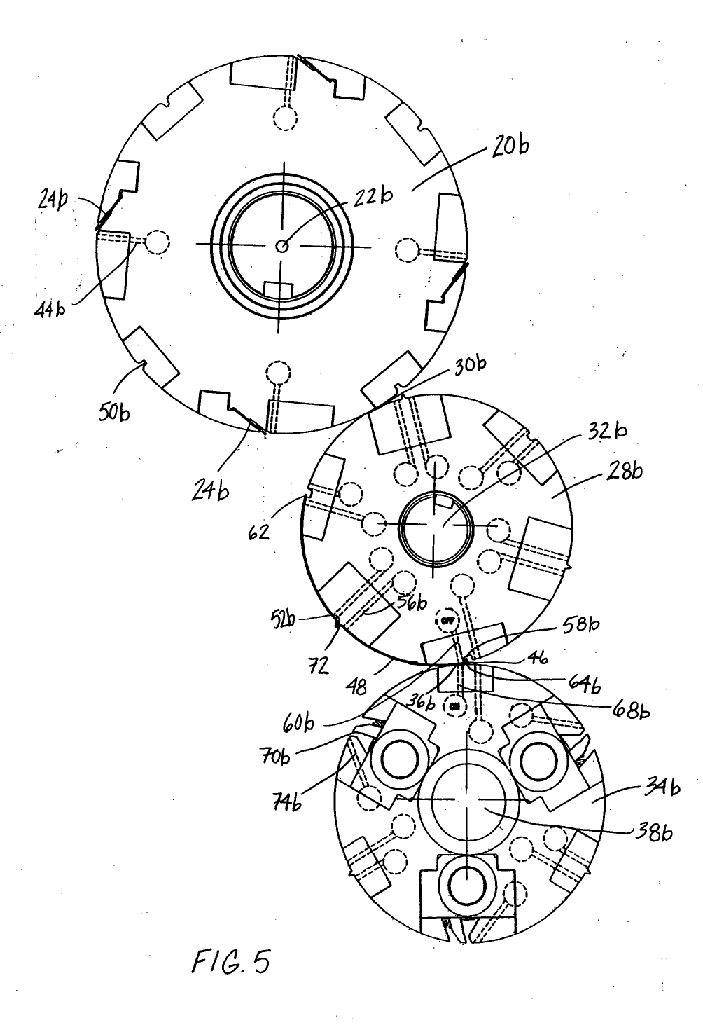

FIG. 5 illustrates the sheet 48 downstream from the position of the sheet 48 shown in FIG. 4. As the transfer roll 28b rotates in a counterclockwise manner, the groove 58b of the transfer roll 28b now partially receives the tucker 64b of the interfolding roll 34b. The vacuum force of vacuum port 74b of interfolding roll 34b is greater than the vacuum force of vacuum port 56b of the transfer roll 28b such that the leading edge 46 of the sheet 48 that is held in the adjacent groove 58b of the transfer roll 28b is released from the vacuum port 56b and held by vacuum port 74b. The leading edge 46 is positioned along the tucker 64b and adjacent the point 66b of the tucker 64b.

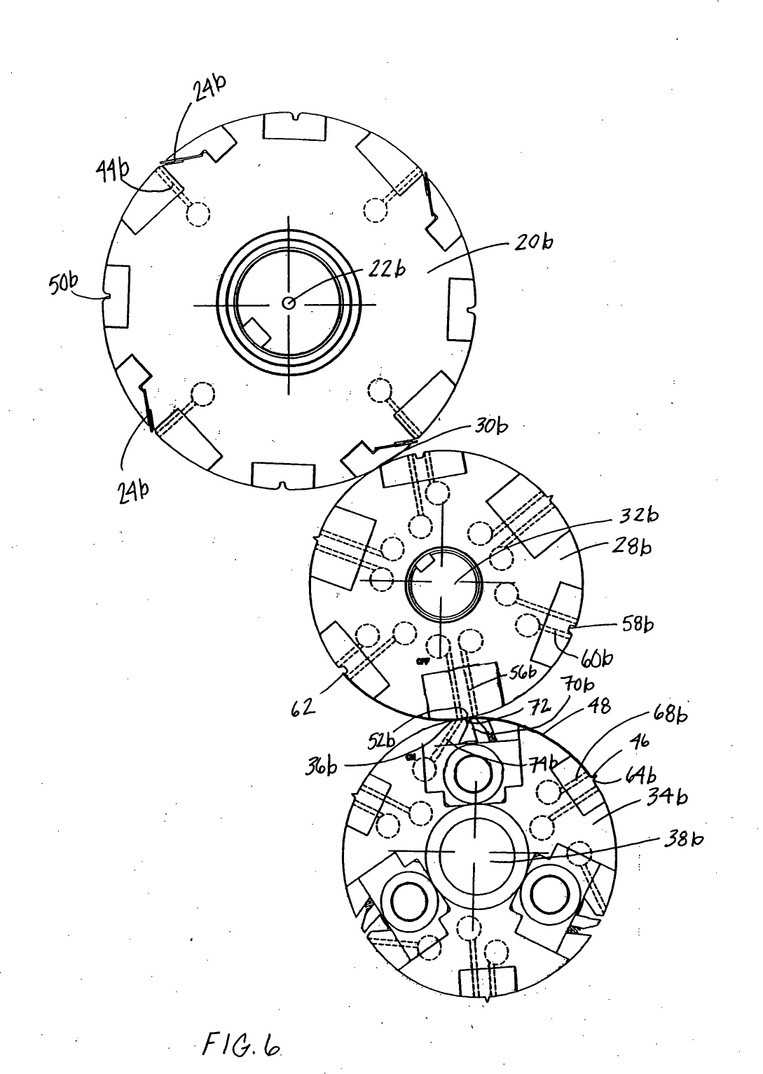

FIG. 6 illustrates the sheet 48 downstream from the position of the sheet 48 shown in FIG. 5. The transfer roll 28b and the interfolding roll 34b have rotated to a position in which the forming blade 52b of the transfer roll 28b and the bent portion of the sheet 48 are inserted into the gripper 70b of the interfolding roll 34b. The suction of the vacuum port 74b of the gripper 70b at that position of rotation of the transfer roll 28b and the interfolding roll 34b is greater than the suction of the two vacuum ports 56b surrounding the forming blade 52b of the transfer roll 28b such that the middle portion 72 of the sheet 48 will be released from vacuum port 56b and held against the vacuum port 74b of the interfolding roll 34b. The vacuum port 74b helps to maintain the middle portion 72 of the sheet 48 in a fixed position relative to the periphery of the interfolding roll 34b. The trailing edge 62 will be ironed against the periphery of the interfolding roll 34b due to the transfer nip 36b defining a tight roll gap that is operable to iron the transferring sheet 48 as the transfer roll 28b and the interfolding roll 34b rotate together.

The transfer roll 28b functions to pre-form sheets of material such that the circumferential length of the sheet along the transfer roll is that same as the circumferential length of the sheet along the interfolding roll to obtain a more accurate fold. This is accomplished by creating a bend in the sheet, and transferring the sheet from the transfer roll to the interfolding roll of the same size such that the bent portion is inserted within the gripper. Because the bent portion is positioned within the gripper, the sheet no longer moves on the interfolding roll to compensate for the amount of sheet forced within the gripper by the opposing tucker. This allows for more accurate control of the positions of the leading and trailing edges of the sheets on the interfolding rolls.

FIG. 7 illustrates the sheet 48 downstream from the position of the sheet 48 shown in FIG. 6. The leading edge 46 of the sheet 48 is positioned near the gripper 70a of the adjacent interfolding roll 34a. If the downstream and upstream sheets were shown on both interfolding rolls 70a, 70b, the leading edge 46 of sheet 48 would still be received by the gripper 70a, but a pre-formed middle portion of a downstream sheet from interfolding roll 70a would be between the leading edge 46 of sheet 48 and the gripper 70a with its pre-formed middle portion 72 positioned within gripper 70a. As interfolding roll 34b rotates clockwise and interfolding roll 34a rotates counterclockwise, the gripper 70b receiving the middle portion 72 of sheet 48 is aligned to receive tucker 64a of interfolding roll 34a. If the downstream and upstream sheets were shown on both rolls, the gripper 70b would also receive the trailing edge of the downstream sheet from interfolding roll 34a and the leading edge of the upstream sheet from interfolding roll 34a as tucker 64a is inserted into gripper 70b.

As sheets continue to progress through the interfolding apparatus 10, the interfolding rolls 34a, 34b will continue to interfold sheets of material in the manner described.

What is claimed is:

1. An interfolding apparatus comprising:
a knife roll rotatable about an axis and operable to cut sheets from a stream of web material issuing from a source in a downstream direction;
a first interfolding roll positioned downstream of the knife roll and adapted to receive the sheets, the first interfolding roll rotatable in a first direction;
a second interfolding roll rotatable in a second direction and disposed adjacent to the first interfolding roll to define a nip therebetween, the first and second interfolding rolls rotatable to interfold the sheets with additional sheets received by the second interfolding roll; and
a transfer roll positioned between the knife roll and the first interfolding roll, the transfer roll having a non-uniform surface configuration, the transfer roll rotatable in the second direction and operable to receive the sheets from the knife roll, to form a bend in each of the sheets received from the knife roll, and to transfer the formed sheets to the first interfolding roll.

2. The apparatus of claim 1, wherein the transfer roll includes a plurality of forming blades, and wherein each of the plurality of forming blades contacts a middle portion of a respective sheet to form the bend in the middle portion of the sheet.

3. The apparatus of claim 2, wherein the interfolding roll includes a plurality of grippers, and wherein each of the plurality of grippers receives one of the plurality of tuckers during the transfer of the sheet from the transfer roll to the first interfolding roll.

4. The apparatus of claim 1, wherein the transfer roll includes a plurality of vacuum ports, and wherein a first vacuum port of the plurality of vacuum ports retains a leading edge of the sheet and wherein a second vacuum port of the plurality of vacuum ports retains a trailing edge of the sheet.

5. The apparatus of claim 1, wherein the first interfolding roll includes a plurality of vacuum ports, and wherein a third vacuum port of the plurality of vacuum ports retains a leading edge of the sheet, and wherein a fourth vacuum port of the plurality of vacuum ports retains a trailing edge of the sheet.

6. The apparatus of claim 1, wherein each sheet has a leading edge, a middle portion, and a trailing edge, and wherein the leading edge of each sheet on the transfer roll remains the leading edge of the sheet on the first interfolding roll after being transferred to the first interfolding roll.

7. The apparatus of claim 1, wherein each sheet extends across a circumferential length on the cutting roll and extends across a second circumferential length on the transfer roll, wherein the first circumferential length is greater than the second circumferential length.

8. The apparatus of claim 1, wherein each sheet extends across a first circumferential length on the transfer roll and a second circumferential length on the first interfolding roll, wherein the first circumferential length is the same as the second circumferential length.

9. The apparatus of claim 1, wherein the knife roll is disposed adjacent the transfer roll to define a nip therebetween, wherein each sheet is transferred directly from the knife roll to the transfer roll.

10. The apparatus of claim 9, wherein the transfer roll includes at least one tucker and the knife roll includes at least one groove, the tucker forcing a portion of a sheet within the groove during rotation of the knife roll and transfer roll to form the bend.

11. The apparatus of claim 1, wherein the transfer roll is disposed adjacent to the first interfolding roll to define a nip therebetween, wherein each sheet is transferred directly from the transfer roll to the first interfolding roll.

12. The apparatus of claim 11, wherein the nip between the transfer roll and the first interfolding roll defines a tight roll gap operable to iron the transferred sheet as the transfer roll and first interfolding roll rotate together.

13. The apparatus of claim 1, wherein the knife roll, the transfer roll, and the first interfolding roll include vacuum ports operable to transfer sheets from the knife roll to the transfer roll and to transfer sheets from the transfer roll to the first interfolding roll.

14. The apparatus of claim 1, wherein the transfer roll defines a roll radius, and wherein the bend is substantially different from the roll radius.

15. The apparatus of claim 14, wherein the bend defines a bend radius, the bend radius being substantially smaller than the roll radius.

16. A method of interfolding sheets of material, the method comprising:
issuing web material in a downstream direction from a source;
cutting with a knife roll the stream of web material into sheets;
transferring each sheet to a transfer roll;
forming with the transfer roll a bend in the middle portion of each sheet;
transferring each formed sheet to an interfolding roll; and
interfolding the formed sheet on the interfolding roll with at least one other sheet from an adjacent interfolding roll.

17. The method of claim 16, further comprising
extending each sheet across a first circumferential length on the knife roll; and
extending each sheet across a shorter, second circumferential length on the transfer roll.

18. The method of claim 17, further comprising
extending each sheet across a third circumferential length on the first interfolding roll that is the same as the second circumferential length.

19. The method of claim 16, further comprising
maintaining a leading edge of each formed sheet on the transfer roll as the leading edge of the formed sheet on the interfolding roll.

20. The method of claim 16, wherein transferring each formed sheet to an interfolding roll includes transferring a leading edge of the formed sheet on the transfer roll to the first interfolding roll.

21. The method of claim 16, wherein forming a bend includes forcing a middle portion of a sheet within a groove of the knife roll with a forming blade of the transfer roll.

22. The method of claim 16, further comprising receiving the bend of the sheet in a gripper of one of the interfolding rolls and inserting a tucker of the adjacent interfolding roll into the gripper after the sheet has been received in the gripper.
